(19) United States
(12) Patent Application Publication
(10) Pub. No.: US 2023/0145224 A1
(43) Pub. Date: May 11, 2023

(54) HEAT RESISTANT AROMATIC POLYCARBONATE - POLYESTER COMPOSITION

(71) Applicant: SABIC GLOBAL TECHNOLOGIES B.V., BERGEN OP ZOOM (NL)

(72) Inventors: Roshan Kumar Jha, Bangalore (IN); Dominique Daniel Arnould, Geleen (NL); Ying Xi, Shanghai (CN); Sijun Li, Shanghai (CN); Subodh Kumar Pal, Bangalore (IN)

(21) Appl. No.: 17/912,310

(22) PCT Filed: Mar. 19, 2021
(86) PCT No.: PCT/EP2021/057075

§ 371 Date: Sep. 16, 2022

(30) Foreign Application Priority Data
Mar. 20, 2020 (EP) 20164623.9
Mar. 20, 2020 (EP) 20164627.0
Mar. 20, 2020 (EP) 20164651.0

(51) Int. Cl. C08L 69/00; C08L 67/02

(52) U.S. Cl. CPC C08L 69/00; C08L 67/02; C08L 2205/035; C08L 2205/025

(57) ABSTRACT

The present invention relates to a composition comprising from 25-75 wt. % of aromatic polycarbonate comprising melt polycarbonate and from 75-25 wt. % of polyester based on the combined weight of the aromatic polycarbonate and the polyester, wherein said polyester comprises poly(butylene terephthalate), and wherein said aromatic polycarbonate has an endcap level of at least 75 mol %. The present invention further relates to an article comprising or consisting of such a composition.

The present invention relates to a composition comprising from 25-75 wt. % of aromatic polycarbonate comprising melt polycarbonate and from 75-25 wt. % of polyester based on the combined weight of the aromatic polycarbonate and the polyester.

The present invention further relates to an article comprising or consisting of such a composition.

Aromatic polycarbonate-polyester compositions are useful in the manufacture of articles and components for a wide range of applications, from automotive parts to electronic appliances.

Aromatic polycarbonates are generally manufactured using two different technologies. In the first technology, known as the interfacial technology or interfacial process, phosgene is reacted with bisphenol A (BPA) in a liquid phase. In this process the aromatic polycarbonate chains will grow, i.e. the molecular weight increases, until the reaction is stopped by means of addition of a chain-terminating agent, also referred to as end-capping agent. Typically, such end-capping agents are mono-hydroxy compounds such for example phenol. Due to the nature of the interfacial technology end-capping levels of the aromatic polycarbonate are very high, which means that the aromatic polycarbonate obtained via the interfacial technology will have a relatively low amount of terminal hydroxyl groups at the end of the aromatic polycarbonate chains. Consequently, such aromatic polycarbonates generally have very good long-term heat stability. Although this process produces the desired polymer, there are disadvantages associated with it. For example, phosgene is extremely toxic and hence results in safety concerns. In addition, methylene chloride, which is often used as a solvent in the interfacial process, raises environmental concerns.

Another well-known technology for the manufacture of aromatic polycarbonate is the so-called melt technology, sometimes also referred to as melt transesterification, melt process, or melt polycondensation technology. In the melt technology, or melt process, a bisphenol, typically bisphenol A (BPA), is reacted with a carbonate, typically diphenyl carbonate (DPC), in the melt phase. The reaction between DPC and BPA releases phenol, which needs to be removed from the reaction mixture in order to progress the polymerization reaction. Typically, the melt process is carried out in a number of stages with increasing temperatures and decreasing pressures until a desired molecular weight is obtained. Due to the nature of the melt process, the resulting aromatic polycarbonate typically has a significantly higher amount of terminal hydroxyl groups. Due to this, the obtained aromatic polycarbonate, in comparison with the interfacially manufactured aromatic polycarbonate, has a lower long term heat stability performance. Polycarbonate manufactured with the interfacial process is referred to herein as interfacial polycarbonate whereas polycarbonate manufactured with the melt process is referred to herein as melt polycarbonate.

WO 2014/097196 discloses a composition made by a process comprising melt blending (a) from 10 to 70 weight percent of a partially crystalline polyester component selected from poly(butylene terephthalate), poly(ethylene terephthalate), poly(butylene terephthalate) copolymers, poly(ethylene terephthalate) copolymers, and combinations thereof; (b) from 10 to 60 weight percent of an amorphous polycarbonate having a Fries rearrangement of greater than 150 to 10,000 ppm; (c) from 5 to 50 weight percent of a filler; and (d) optionally, from 0.01 to 10 wt. % of an antioxidant, mold release agent, colorant, stabilizer, or a combination thereof; wherein the melt blended composition has a polycarbonate aryl hydroxy end-group content of at least 300 ppm; and wherein the composition, when molded into an article having a 2.0 mm thickness, provides a near infrared transmission at 960 nanometers of greater than 45%.

WO 2017/093232 discloses a thermoplastic composition comprising 0 to 50 weight percent of a polycarbonate, 10 to 50 weight percent of a polyester carbonate copolymer, 5 to 20 weight percent of a poly(ethylene terephthalate), 20 to 50 weight percent of a poly(butylene terephthalate), and optionally 5 to 30 weight percent of an impact modifier, wherein weight percent is based on the combined amounts of polycarbonate, polyester carbonate copolymer, poly(ethylene terephthalate), poly(butylene terephthalate) and optional impact modifier.

The present inventors have found that a composition comprising aromatic polycarbonate and poly(butylene terephthalate) wherein the aromatic polycarbonate comprises melt polycarbonate has a lower heat resistance compared to an otherwise identical composition but wherein the aromatic polycarbonate comprises interfacial polycarbonate. In that respect the term heat resistance means the resistance to deformation upon increasing temperature such as typically measured as a Vicat softening temperature and/or a heat distortion temperature, sometimes also referred to as heat deflection temperature.

It is an object of the invention to provide a composition comprising aromatic polycarbonate and polyester having a good heat resistance.

More in particular it is an object to provide such a composition wherein the aromatic polycarbonate comprises or consists of melt polycarbonate and the polyester comprises or consists of poly(butylene terephthalate).

The present inventors surprisingly found that compositions comprising melt polycarbonate and poly(butylene terephthalate) wherein the aromatic polycarbonate has a relatively high endcap level, shows improved heat resistance properties.

Accordingly the present invention relates to a composition comprising 25-75 wt. % of aromatic polycarbonate comprising melt polycarbonate and from 75-25 wt. % of polyester based on the combined weight of the aromatic polycarbonate and the polyester, wherein said polyester comprises poly(butylene terephthalate) and wherein said aromatic polycarbonate has an endcap level of at least 75 mol %, preferably at least 80 mol %.

By application of the invention, the foregoing objects are met, at least in part.

A polycarbonate obtained by the melt transesterification process is known to be structurally different from polycarbonate obtained by the interfacial process. In that respect it is noted that in particular melt polycarbonate typically has a minimum amount of Fries branching, which is generally absent in interfacial polycarbonate.

In view of the difference between these two processes also the terminal hydroxyl group content typically differs. In the interfacial process typically the end-capping levels of the aromatic polycarbonate are very high 90 mol %) and thereby all of the terminal hydroxyl groups can be end-capped with an endcapping agent so that the terminal hydroxyl group content for interfacial polycarbonate can be as low as 0 ppm. On the other hand the melt polycarbonate process typically results in polycarbonate having a terminal hydroxyl group content of at least about 150 ppm, at least 200 or at least 250 ppm.

### Polycarbonate

The aromatic polycarbonate in the composition according to the invention comprises melt polycarbonate and has an endcap level of at least 75 mol %, preferably at least 80 mol %, more preferably at least 85 mol %. The endcap level may be at most 95 mol %, such as at most 90 mol %. For the purpose of the present invention, it is noted that the endcap level is considered as a value measured on the aromatic polycarbonate of the composition.

The aromatic polycarbonate may be a mixture of melt polycarbonate and a polycarbonate not manufactured using the melt process such as the interfacial process, as long as the endcap level is at least 75 mol %. Thus, by way of example an amount of interfacial polycarbonate with an endcap level of about 100 mol % may be mixed with an amount of melt polycarbonate having an endcap level of about 60 mol % as long as the measured encap level of the mixture is at least 75 mol %.

For the avoidance of doubt the interfacial polycarbonate, if any, may be a mixture of two or more interfacial polycarbonates. Likewise, the melt polycarbonate may be a mixture of two or more melt polycarbonates.

It is preferred that the aromatic polycarbonate contains at least 50 wt. %, more preferably at least 75 wt. %, more preferably at least 85 wt. %, even more preferably at least 95 wt. % of melt polycarbonate, based on the amount of the aromatic polycarbonate. The aromatic polycarbonate may essentially consist or consist of melt polycarbonate provided of course that the aromatic polycarbonate has an endcap level of at least 75 wt. %. Thus, if the aromatic polycarbonate consists of melt polycarbonate then the melt polycarbonate has an endcap level of at least 75 mol %.

If the aromatic polycarbonate consists of melt polycarbonate then the melt polycarbonate may be a mixture of two melt polycarbonates, for example a mixture of melt polycarbonates, which mutually differ in molecular weight, Fries branching, and/or endcap level. Preferably, the aromatic polycarbonate consists of a melt polycarbonate with an endcap of at least 75 mol %.

The composition of the invention generally does not comprise polycarbonate other than aromatic polycarbonate. The aromatic polycarbonate is not a polyester carbonate.

The melt polycarbonate is an aromatic polycarbonate obtained by reacting a bisphenol and a diarylcarbonate, where the bisphenol is preferably bisphenol A (BPA) and the diarylcarbonate is preferably diphenyl carbonate (DPC). The aromatic polycarbonate is preferably a linear aromatic polycarbonate meaning that the melt transesterification is carried out on the basis of the bisphenol and diarylcarbonate in absence of any branching agent, such as for example multi-functional alcohols. For the purpose of the present invention, the melt polycarbonate may however be branched or linear.

Notwithstanding the foregoing it is well known that the melt transesterification process for the manufacture of polycarbonate, wherein bisphenol a and diphenyl carbonate are reacted in molten conditions thereby releasing phenol, results in a certain amount of branching, known as Fries branching. The amount of Fries branching depends inter alia on the type and amount of transesterification catalyst that is used as well as the reaction conditions that are applied, in particular the temperature, pressure and residence times. Thus, a linear polycarbonate in the context of the present invention will contain a certain amount of Fries branching. It is however to be understood that the polycarbonate in the present invention is preferably manufactured in absence of a branching agent, i.e. an agent that includes three or more functional groups and thereby introduces branching or crosslinking of the polycarbonate.

The amount of Fries branching is at least 1200 ppm, preferably 1300 ppm, more preferably 1500 ppm and at most 2000 ppm. The term Fries branching is known to the skilled person and refers inter alia to the structures as disclosed in EP2174970 and reproduced below as structures (1) to (5), yet may include further branched structures.

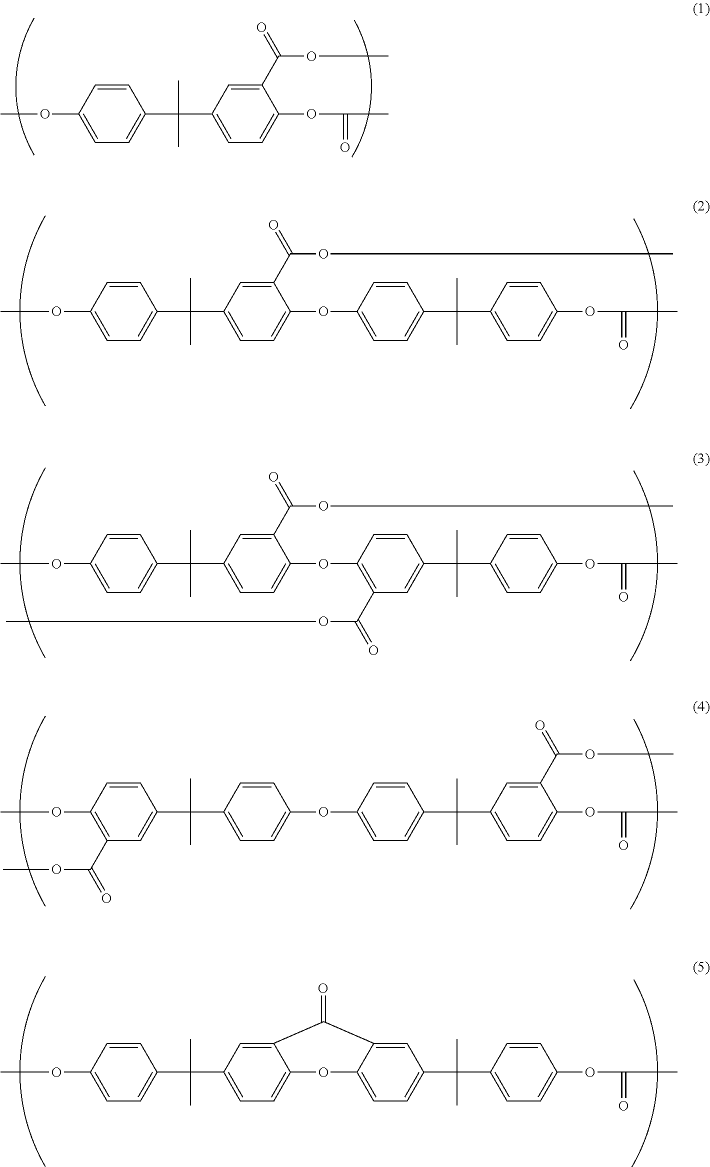

WO 2011/120921 discloses that units such as disclosed in EP 217940 are Fries branching species. Methods for determining the amount of Fries branching are known to the skilled person and generally include the methanolysis of the polycarbonate followed by HPLC chromatography to identify the total amount of Fries structures. In addition, NMR techniques can be used to determine the type and amount of these Fries structures, such as the respective amounts of linear and branched Fries structures.

It is preferred that the polycarbonate has a weight average molecular weight, Mw, of at least 15,000 to 60,000 g/mol, determined on the basis of polystyrene standards.

The desired endcap level of the melt polycarbonate can be obtained in several ways. For example, the endcap level can be set by selecting the appropriate processing conditions during the melt polycondensation reaction. In particular, the ratio of diaryl carbonate to bisphenol and in addition to that, the type and amount of catalyst can be used to control the endcap level.

Alternatively or in addition to this an end-capping agent (also referred to as a chain stopper agent or chain-terminating agent) can be included during polymerization to provide end groups. The end-capping agent (and thus end groups) are selected based on the desired properties of the polycarbonates. The end-capping agent is preferably selected from paracumyl phenol, dicumyl phenol, p-tert-butyl phenol and mixtures of at least two of said end-capping agents.

The amount of end-capping agent to be employed depends on the exact location and conditions of where the end-capping agent is introduced during the melt transesterification process and further on the type and the desired level of end-capping of the polycarbonate.

The endcap level is calculated with the following Formula I

$$\% EC = 100 - ( \frac{ppmOH \times Mn}{340000} ) \qquad I$$

wherein % EC is the endcap level, ppmOH is the amount of hydroxyl end groups in parts per million by weight and Mn is the number average molecular weight of the polycarbonate based on polycarbonate standards.

In accordance with the invention, the aromatic polycarbonate has an endcap level of at least 75 mol % wherein the endcap level is defined as the percentage of polycarbonate chain ends which are not hydroxyl groups. Thus, a polycarbonate having and endcap level of 75 mol % means that the polycarbonate has 25 mol % of chain ends that are phenolic OH end groups, usually resulting from the bisphenol A monomer. The other 75 mol % of end groups do not contain a OH end group and may be phenolic or correspond to the end capping agent molecule(s).

The amount of chain ends that are end-capped with the end-capping agent is preferably at least 25 mol % on the basis of the total amount of end-groups.

The endcap level is defined as the mole percentage of end-groups of the polycarbonate that is not a hydroxyl group and can be calculated from the amount of terminal OH groups in the polycarbonate and the number average molecular weight (Mn) in accordance with Formula I.

The aromatic polycarbonate in accordance with the invention, whether it consists of melt polycarbonate or is comprised of a mixture comprising melt polycarbonate is preferably bisphenol A polycarbonate homopolymer. Thus, when the aromatic polycarbonate consists of melt polycarbonate then the melt polycarbonate is preferably bisphenol A polycarbonate homopolymer and when the aromatic polycarbonate comprises melt polycarbonate and one or more further polycarbonates, such as interfacial polycarbonate, then preferably all polycarbonate is bisphenol A polycarbonate homopolymer.

The aromatic polycarbonate in accordance with the invention preferably does not comprise a copolymer, such as for example polycarbonate-polysiloxane copolymers or polycarbonate-polyester copolymers.

It is further preferred that apart from aromatic polycarbonate the composition as disclosed herein does not comprise non-aromatic polycarbonate.

### Polyester

The polyester of the composition disclosed herein comprises, essentially consists of or consists of poly(butylene terephthalate). The poly(butylene terephthalate) may be a mixture of two or more different poly(butylene terephthalate)s, for example a mixture of poly(butylene terephthalate)s with mutually different molecular weights.

Polyesters like poly(butylene terephthalate) and polyethylene terephthalate are known to a skilled person per se. In a particularly preferred embodiment, the said polyester comprises poly(butylene terephthalate) (PBT).

It is preferred that the poly(butylene terephthalate) has a weight average molecular weight of 50,000 to 150,000 g/mol as determined using gel permeation chromatography with polystyrene standards.

It is preferred that the polyester in the composition contains at least 25 wt. %, preferably at least 50 wt. %, more preferably at least 75 wt. % of poly(butylene terephthalate) based on the amount of polyester. The polyester may also comprise at least 95 wt. % or 99 wt. % of poly(butylene terephthalate) or may essentially consist or consist of poly(butylene terephthalate).

In order to further increase the heat resistance the polyester may comprise another polyester, miscible with poly(butylene terephthalate), having a higher heat resistance compared to the heat resistance of virgin poly(butylene terephthalate). Accordingly, it may be preferred that the polyester comprises polyethylene terephthalate, polyethylene naphthalate (PEN), Polybutylene naphthalate (PBN), polytrimethylene terephthalate (PTT) or combinations thereof.

Polyethylene terephthalate is a well known polyester and readily available. The polyethylene terephthalate may be a mixture of two or more different polyethylene terephthalates, for example a mixture of polyethylene terephthalates with mutually different molecular weights.

Other polyester having a similar effect may include polyethylene naphthalate (PEN), Polybutylene naphthalate (PBN), polytrimethylene terephthalate (PTT). It can also include a branched polyester, in which a branching agent, for example, a glycol having three or more hydroxyl groups or a trifunctional or multifunctional carboxylic acid has been incorporated, can be used.

The amount of polyester other than poly(butylene terephthalate), such as in particular polyethylene terephthalate, may be at most 50 wt. %, preferably at most 35 wt. %, more preferably at most 15 wt. % based on the weight of polyester in the composition.

### Nucleating Agents

The composition disclosed herein can further include one or more nucleating agents. In that respect, the term nucleating agent refers to an additive that enhances the formation of crystals in the polyester phase of the composition. Addition of a nucleating agent will accordingly increase the crystallinity of the polyester phase, which results in an increased heat resistance. Talc is particularly preferred as nucleating agent. The composition preferably comprises, based on the weight of the composition, from 0.01 to 5 wt. %, preferably from 0.02 to 1 wt. % and particularly preferably from 0.05 to 0.2 wt. %, of nucleating agents.

### Other Additives

Typical additives that are used in the composition can comprise one or more of an impact modifier, flow modifier, filler, reinforcing agent (e.g., glass fibers or glass flakes), antioxidant, heat stabilizer, light stabilizer, UV light stabilizer and/or UV absorbing additive, plasticizer, lubricant, release agent, in particular glycerol monostearate, pentaerythritol tetra stearate, glycerol tristearate, stearyl stearate, antistatic agent, antifog agent, antimicrobial agent, colorant (e.g., a dye or pigment), flame retardant either or not combined with an anti-drip agent such as polytetrafluoroethylene (PTFE) or PTFE-encapsulated styrene-acrylonitrile copolymer.

Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used. The amount of impact modifier may be from 1-20 wt. %, preferably from 5-15 wt. % based on the weight of the composition.

The compositions can be manufactured by various methods known in the art. For example, polycarbonate, poly(butylene terephthalate), poly(ethylene terephthalate), and other components are first blended, optionally with any fillers or additives, in a high speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a masterbatch with a desired polymer and fed into the extruder. The extruder is generally operated at a temperature higher than that necessary to cause the composition to flow. The extrudate can be immediately cooled in a water bath and pelletized. The pellets so prepared can be one-fourth inch long or less as desired. Such pellets can be used for subsequent molding, shaping, or forming.

Shaped, formed, or molded articles comprising the compositions are also provided. The compositions can be molded into useful shaped articles by a variety of methods, such as injection molding, extrusion, blow molding and thermoforming. Some example of articles include automotive and vehicular body panels such as bumper covers and bumpers or a housing for electrical equipment.

Accordingly, the present invention relates to an article comprising or consisting of the composition disclosed herein.

More in particular thet present invention relates to vehicular body parts or for housing of electrical equipment comprising or consisting the composition disclosed herein. Likewise, the present invention relates to a vehicle or an electrical equipment comprising said vehicular body part or said housing.

The present invention relates to the use of the composition disclosed herein for the manufacture of an article of manufacture, such as an automotive part.

The present invention further relates to the use of melt polycarbonate having an endcap level of at least 75 mol % in a composition comprising from 25-75 wt. % of said melt aromatic polycarbonate and from 75-25 wt. % of polyester comprising poly(butylene terephthalate), based on the combined weight of the aromatic polycarbonate and the polyester, for improving the heat stability, preferably the vicat softening temperature and/or the heat distortion temperature, of said composition when compared to an otherwise identical composition comprising melt aromatic polycarbonate having an endcap level of less than 75 mol %, preferably less than 65 mol %.

### Composition

It is preferred that the composition disclosed herein comprises from 25-75 wt. % of aromatic polycarbonate and from 75-25 wt. % polyester.

In an aspect, it is preferred that the aromatic polycarbonate consists of melt polycarbonate and that the polyester consists of poly(butylene terephthalate).

In another aspect it is preferred that the aromatic polycarbonate consists of melt polycarbonate and that the polyester consists of a mixture of poly(butylene terephthalate) and polyethylene terephthalate.

It is preferred that the composition as disclosed herein has a Vicat softening point, as determined by ISO-306 B120 at a load of 50N and a speed of 120° C./hr of at least 90% of the Vicat softening point of an otherwise identical composition wherein the aromatic polycarbonate consists of interfacial polycarbonate. For the avoidance of doubt, the term “otherwise identical” means only the indicated material, in this case the aromatic polycarbonate is different. All other materials of the composition and their respective amounts are identical.

It is preferred that the composition as disclosed herein has a heat distortion temperature, as determined by as determined by ISO 75 flatwise at a load of 0.45 MPa, of at least 90% of the heat distortion temperature of an otherwise identical composition wherein the aromatic polycarbonate consists of interfacial polycarbonate.

In the composition disclosed herein the combined amount of polyester and aromatic polycarbonate is preferably at least 85 wt. %, more preferably at least 90 wt. %, 95 wt. % or 98 wt. % based on the total weight of the composition.

It is preferred that the composition comprises at most 3 wt. %, based on the weight of the composition, of a filler such as a glass or glassy filler, specifically a glass fiber, a glass flake, and a glass bead, talc, or mica.

It is preferred that the composition does not contain fillers and in particular that the composition does not contain one or more of glass fibers, glass flakes, glass beads talc or mica, provided that talc may be added in an amount of at most 1 wt. %.

The present invention will now be further elucidated based on the following non-limiting examples.

### Test Methods

### Fries Branching:

The amount of Fries branching was determined using an Agilent 1100series HPLC equipped with a MWD G1365B detector. The column is an Agilent Zorbax Eclipse XDB-C18 4.6×75 mm. The injection volume is 50 ml. The oven temperature is 35° C. and the wavelength to acquire data is 320.16 nm. For sample preparation 0.3 g of sample is dissolved in 7.5 ml of a solvents mixture based on 5 ml of tetrahydrofuran and 2.5 ml of a 10% of potassium hydroxide solution in methanol, after heating this sample at 40° C. during 20 min, 1.4 ml of acetic acid is added.

### Molecular Weight

The molecular weight of the polycarbonate and poly(butylene terephthalate) was measured by GPC method with polystyrene standard in an Agilent 1260 Infinity (SYS-LC-1260) equipment with PLGel 5 um Minimix C 250 ×4.6 mm column and Refractive Index detector. The sample is dissolved in dichloromethane and the same solvent is used as carrier. Based on the molecular weight determined based on polystyrene standards (number average), the endcap level for polycarbonate can be calculated.

### Viscosity

The intrinsic viscosity of the polyesters was measured in 1:1 weight to weight mixture of phenol:1,1,2,2-tetrachloro ethane at 30° C.

### Endcap Level

The endcap level was determined based on UV measurement to determine the amount of terminal OH groups. Combined with the number average molecular weight the endcap level is then determined in accordance with Formula I. The UV spectrophotometer was a Perkin Elmer Lambda 800. Measurements were carried out on 0.01 g of a polycarbonate sample diluted in 10 ml of dichloromethane and placed into a quartz cuvette of 10 mm of optical path. The wavelength to acquire data are 284 and 292 nm. The results from the equipment as ppm of OH are used to calculate the endcap using also the molecular weight of the polycarbonate and according to the formula for calculation as disclosed herein.

### End-Capping Agent Concentration

The amount of polymer chains end-capped with the added end-capping agent was determined based on HPLC measurement using the same procedure techniques as for the Fries branching. The amount of bulky end-groups equals the sum of the amount of OH end-groups (originating from BPA) and the amount of end-groups. Preferably, the amount of bulky end groups is at least 75%, more preferably at least 80%. This percentage is a mol %.

### Vicat Softening Temperature (Vicat)

The Vicat softening point (in ° C.) was determined in accordance with ISO 306 at a load of 50N and a speed of 120° C./hr on injection molded samples.

### Heat Distortion Temperature (HDT)

The heat distortion temperature, HDT (in ° C.) was determined in accordance with ISO 75 flatwise at a load of 0.45 MPa.

### Impact

The notched Izod impact strength was determined in accordance with ISO 180/1A on injection molded samples measurements 80×10×4 mm. The depth under the notch of the specimen is 8 mm.

### Tensile Modulus

The tensile modulus (in units of gigapascals; Gpa) and % nominal strain at break were tested according to ISO 527 measured at room temperature (23 degC).

### Melt Volume Rate (MVR)

The MVR (cm³/10 min) of the composition was measured in accordance with ASTM D 1238 at 250° C. under load of 5 kg.

### Glass Transition Temperature (Tg)

Glass transition temperatures were determined by dual cantiliver three point bending dynamic rheology wherein the temperature was increased from 23° C. to 250° C. and frequency of 6.28 rad/sec.

### EXAMPLES

The examples were made by melt mixing the materials in a 25 mm twin screw extruder. All components were dry-mixed and added to the throat of the extruder. The extruder was set with barrel temperatures between 150° C. and 260° C. The material was run maintaining torque of 55-60% with a vacuum of 100-800 mbar applied to the melt during compounding. The composition was pelletized after exiting the die head.

TABLE 1
Components of the compositions and their source

| Component | Trade name/Supplier |
|---|---|
| PC1 | A Polycarbonate produced by interfacial route from |
| | Bisphenol A and Phosgene having MVR of 6 cc/10 |
| | min, almost 100% capped, Fries branching ~ 0 ppm |
| | and available from SABIC. |
| PC2 | Polycarbonate produced via the melt transesterifi- |
| | cation of diphenyl carbonate and bisphenol A, and |
| | having a MVR of 6 cc/10 min, an endcap level of 65% |
| | and an amount of Fries branching of 1100 ppm and |
| | available from SABIC. |
| PC3 | Polycarbonate produced via the melt transesterifi- |
| | cation of diphenyl carbonate and bisphenol A, and |
| | having a MVR of 6 cc/10 min, an endcap level of 45% |
| | and an amount of Fries branching of 1100 ppm. |
| PC4 | Polycarbonate produced via the melt transesterifi- |
| | cation of diphenyl carbonate and bisphenol A, and |
| | having a MVR of 6 cc/10 min, an endcap level of 85% |
| | and an amount of Fries branching of 1100 ppm. |
| PC5 | Polycarbonate produced via the melt transesterifi- |
| | cation of diphenyl carbonate and bisphenol A, having |
| | a MVR of 6 cc/10 min, an endcap level of 85% and an |
| | amount of Fries branching of 1400 ppm. |
| PBT | A poly(butylene terephthalate) having an intrinsic |
| | viscosity of 1.2 dl/g available from Chang Chun |
| | Plastics, Taiwan - grade used PBT 315 |
| PET1 | A polyethylene terephthalate having an intrinsic |
| | viscosity of 0.8 dl/g, RELPET G5801 available from |
| | Reliance Industries, India |
| PET2 | A polyethylene terephthalate (grade name BC 212) |
| | having an intrinsic viscosity of 0.84 dl/g available |
| | from SABIC, KSA |
| PET3 | A polyethylene terephthalate (grade name BC 211) |
| | having an intrinsic viscosity of 0.76 dl/g available |
| | from SABIC, KSA |
| Quencher | Monozinc Phosphate |
| Nuleating | Fine talc of around 1 micron, commercially available |
| agent | as Jetfine 3 CA from the company Imerys |
| Stabilizer | Pentaerythritol tetrakis[3-[3,5-di-tert-butyl-4- |
| | hydroxyphenyl]propionate, commercially available |
| | under the name Irganox 1010 from Ciba Specialty |
| | Chemicals |
| Impact | MBS core shell impact modifier, Paraloid |
| Modifier | EXL ™ 2650J commercially available from Dow, |
| | Singapore |

TABLE 2
Formulations and properties for the
PC - PBT (in absence of impact modifier)

| | CE 1 | CE 2 | CE 3 | Ex 1 | Ex 2 |
|---|---|---|---|---|---|
| PC1 | 49.91 | | | | |
| PC2 | | 49.91 | | | |
| PC3 | | | 49.91 | | |
| PC4 | | | | 49.91 | |
| PC5 | | | | | 49.91 |
| PBT | 49.91 | 49.91 | 49.91 | 49.91 | 49.91 |
| Quencher | 0.1 | 0.1 | 0.1 | 0.1 | 0.1 |
| Stabilizer | 0.08 | 0.08 | 0.08 | 0.08 | 0.08 |
| HDT (° C.) @ 1.8 Mpa | 117.9 | 111.2 | 107 | 115.8 | 117.7 |
| VST (° C.) @ 120 B | 136.4 | 132.1 | 129.8 | 134.8 | 134.9 |

### Comparative Examples 1-3 and Examples 1-2

Comparative Example 1 demonstrates the Vicat and HDT values of a composition in the where the polycarbonate has been prepared by the interfacial process. Comparative Examples 2 and 3 demonstrate the Vicat and HDT values of a composition, where the aromatic polycarbonate has been prepared by the melt process. The amounts in Table 2 are in weight percent based on the total weight of the composition. In all the examples, the total amount of components, equals 100 weight percent. Table 2 shows that addition of aromatic polycarbonate prepared by the melt process wherein the polycarbonate has higher endcap levels of at least 75 mol %. surprisingly leads to an increase in the heat resistance. When comparing to the reference sample with lower end cap level, the increase can be as high as 5° C. for Vicat and 8.8° C. for HDT (Ex. 1 compared to CE 3).

### Comparative Examples 4-6 and Examples 3-4

Comparative Example 4 demonstrates the Vicat and HDT values of a composition in the where the polycarbonate has been prepared by the interfacial process, in presence of an impact modifier. Comparative Examples 5 and 6 show that with the introduction of aromatic polycarbonate that has been prepared by the melt process, the Vicat and HDT values decrease. Table 3 shows that addition of aromatic polycarbonate prepared by the melt process wherein the polycarbonate has higher endcap levels of at least 75 mol % surprisingly leads to an increase in the heat resistance. Subsequently the mechanical properties are retained as demonstrated by the tensile modulus, tensile strain, tensile strength and the NII values in Table 3.

TABLE 3
Formulations and properties for the
PC - PBT (in presence of impact modifier)

| | CE 4 | CE 5 | CE 6 | EX 3 | EX 4 |
|---|---|---|---|---|---|
| PC1 | 44.91 | | | | |
| PC2 | | 44.91 | | | |
| PC3 | | | 44.91 | | |
| PC4 | | | | 44.91 | |
| PC5 | | | | | 44.91 |
| PBT | 45 | 45 | 45 | 45 | 45 |
| Impact Modifier | 10 | 10 | 10 | 10 | 10 |
| Quencher | 0.1 | 0.1 | 0.1 | 0.1 | 0.1 |
| Stabilizer | 0.08 | 0.08 | 0.08 | 0.08 | 0.08 |
| Tensile Modulus (Gpa) | 2.2 | 2.3 | 2.2 | 2.2 | 2.2 |
| Tensile Strength (Mpa) | 53 | 54 | 53 | 54 | 54 |
| Tensile strain @ break | 155 | 140 | 152 | 150 | 148 |
| (%) | | | | | |
| NII (KJ/m2) @ 23 C. | 41.9 | 40.9 | 42.5 | 43.5 | 41.8 |
| NII (KJ/m2) @ 0 C. | 46.8 | 48.7 | 52.4 | 50.8 | 50.3 |
| NII (KJ/m2) @ −20 C. | 41.9 | 43.8 | 47.5 | 46.3 | 44.7 |
| NII (KJ/m2) @ −30 C. | 32.8 | 34.6 | 42.1 | 42.1 | 43.3 |
| HDT (C) @ 1.8 Mpa | 80.0 | 74.3 | 72.3 | 81.1 | 79.9 |
| HDT (C) @ 0.45 Mpa | 109.8 | 104 | 97.7 | 107.9 | 106 |
| VST (C) @ 120 B | 127.7 | 124.2 | 121.8 | 126.9 | 126.5 |
| MVR (cc/10 min) @ | 9.7 | 10.7 | 10.7 | 10.4 | 10.4 |
| 250° C., 5 kg | | | | | |

### Comparative Examples 6-7 and Examples 5-6

Table 4 shows that addition of a nucleating agent (such as talc) can further improve heat resistance. In this case, addition of 0.2% talc (CE 4 and Ex 6), leads to an increase of 5 degrees in Vicat. The results from Table 4 also show that the mechanical properties are retained even with addition of the nucleating agent. In all the examples, the total amount of components, equals 100 weight percent.

TABLE 4
Formulations and properties for the
PC - PBT (in presence of nucleating agent)

| | CE 6 | CE 7 | Ex 5 | Ex 6 |
|---|---|---|---|---|
| PC1 | | | | |
| PC2 | | 44.81 | | |
| PC4 | 44.91 | | 44.81 | |
| PC5 | | | | 44.81 |
| PBT | 45 | 44.81 | 44.81 | 44.81 |
| Impact Modifier | 10 | 10 | 10 | 10 |
| Nucleating agent | | 0.2 | 0.2 | 0.2 |
| Quencher | 0.1 | 0.1 | 0.1 | 0.1 |
| Stabilizer | 0.08 | 0.08 | 0.08 | 0.08 |
| Tensile Modulus (Gpa) | 2.2 | 2 | 1.88 | 1.9 |
| Tensile Strength (Mpa) | 53 | 58 | 55 | 55 |
| Tensile strain @ break (%) | 152 | 137 | 135 | 121 |
| HDT (C) @ 1.8 Mpa | 72.3 | 75.6 | 79.2 | 78.7 |
| HDT (C) @ 0.45 Mpa | 97.7 | 104.6 | 108.3 | 107.4 |
| VST (C) @ 120 | 121.8 | 130.3 | 132.7 | 132.2 |
| MVR @ 250 C., 5 kg | 10.7 | 10.18 | 9.29 | 9.28 |

### Comparative Examples 7-8 and Examples 7-9

Table 5 shows that addition of low levels poly(ethylene terephthalate) leads to a considerable increase in heat resistance. When comparing to the reference sample without poly(ethylene terephthalate). When comparing CE 8 to Ex 7-9, which have the same total polyester content, it is observed that also replacement of poly(butylene terephthalate) with poly(ethylene terephthalate) is an effective method to increase heat resistance. In all the examples, the total amount of components, equals 100 weight percent.

TABLE 5
Formulations and properties for the PC -
PBT - PET (in presence of impact modifier)

| | CE 7 | CE 8 | Ex 7 | Ex 8 | Ex 9 |
|---|---|---|---|---|---|
| PC1 | 44.91 | | | | |
| PC2 | | 44.91 | 44.91 | 44.91 | 44.91 |
| PBT | 44.91 | 44.91 | 29.91 | 29.91 | 29.91 |
| PET1 | | | 15 | | |
| PET2 | | | | 15 | |
| PET3 | | | | | 15 |
| Impact Modifier | 10 | 10 | 10 | 10 | 10 |
| Quencher | 0.1 | 0.1 | 0.1 | 0.1 | 0.1 |
| Stabilizer | 0.8 | 0.8 | 0.8 | 0.8 | 0.8 |
| Tensile Strength (MPa) | 57.7 | 55.1 | 55.3 | 56.6 | 57.5 |
| Tensile Modulus (GPa) | 2.07 | 2.1 | 2.07 | 2.1 | 2.2 |
| VST@ 50 C./50N | 125.6 | 120.8 | 125.3 | 125 | 125.4 |
| VST@ 120 C./50N | 127.3 | 121.6 | 127.5 | 126.7 | 131 |
| MVR (cc/10 mins) @ | 11.5 | 11.3 | 10.3 | 6.7 | 6.6 |
| 250 C., 5 kg | | | | | |

1. A composition comprising from 25 wt. % to 75 wt. % of an aromatic polycarbonate comprising a melt polycarbonate and from 75 wt. % to 25 wt. % of a polyester based on the combined weight of the aromatic polycarbonate and the polyester, wherein said polyester comprises poly(butylene terephthalate), and wherein said aromatic polycarbonate has an en cap level of at least 75 mol %.

2. The composition of claim 1, wherein the composition has a Vicat softening point, as determined by ISO-306 B120 at a load of 50N and a speed of 120° C./hr of at least 90% of the Vicat softening point of an otherwise identical composition wherein the aromatic polycarbonate consists of interfacial polycarbonate.

3. The composition of claim 1, wherein the composition has a heat distortion temperature, as determined by as determined by ISO 75 flatwise at a load of 0.45 MPa, of at least 90% of the heat distortion temperature of an otherwise identical composition wherein the aromatic polycarbonate consists of interfacial polycarbonate.

4. The composition of claim 1 further comprising an impact modifier.

5. The composition of claim 1, wherein the melt polycarbonate has a Fries branching content of at most 2000 ppm by weight.

6. The composition of claim 1 further comprising a nucleating agent.

7. The composition of claim 1 wherein the aromatic polycarbonate contains at least 50 wt. %, of the melt polycarbonate, based on the amount of the aromatic polycarbonate.

8. The composition of claim 1, wherein the polyester further comprises poly(ethylene terephthalate), polyethylene naphthalate (PEN), polybutylene naphthalate (PBN), polytrimethylene terephthalate (PTT) or combinations thereof.

9. The composition of claim 1 wherein the polyester contains at least 25 wt. %, of poly(butylene terephthalate) based on the amount of the polyester.

10. The composition of claim 1 wherein the composition comprises at most 3 wt. %, based on the weight of the composition, of a filler.

11. The composition of claim 1 wherein the combined amount of the polyester and the aromatic polycarbonate is at least 85 wt. %, based on the weight of the composition.

12. An article comprising or consisting of the composition of claim 1.

13. A vehicle or an electrical equipment comprising the article of claim 12.

14. (canceled)

15. (canceled)

16. The composition of claim 1, wherein the aromatic polycarbonate has an endcap level of at least 80 mol %.

17. The composition of claim 1, wherein the melt polycarbonate has a Fries branching content of at least 1200 ppm by weight.

18. The composition of claim 1, wherein the aromatic polycarbonate contains at least 75 wt. %, of the melt polycarbonate, based on the amount of the aromatic polycarbonate.

19. The composition of claim 1, wherein the aromatic polycarbonate contains at least 95 wt. %, of the melt polycarbonate, based on the amount of the aromatic polycarbonate.

20. The composition of claim 1, wherein the polyester further comprises poly(ethylene terephthalate).

21. The composition of claim 1 wherein the polyester contains at least 50 wt. %, of poly(butylene terephthalate) based on the amount of the polyester.

22. The article of claim 12, wherein the article is preferably a vehicular body part or a housing for electrical equipment.
